(19) United States
(12) Patent Application Publication
(10) Pub. No.: US 2026/0064442 A1
(43) Pub. Date: Mar. 5, 2026

(54) SCALABLE MODULAR CONFIGURATION FOR HUMAN-MACHINE INTERFACE

(71) Applicant: Caterpillar Inc., Peoria, IL (US)

(72) Inventors: Manoj Kumar BANTUPALLI, Vizianagaram (IN); Ranjay SINGH, Kanpur (IN); Srideep CHATTERJEE, Bhopal (IN); Sowmya NAGESH, Peoria, IL (US)

(73) Assignee: Caterpillar Inc., Peoria, IL (US)

(21) Appl. No.: 18/820,968

(22) Filed: Aug. 30, 2024

(51) Int. Cl. G06F 9/451; G06F 3/0484

(52) U.S. Cl. CPC G06F 9/451; G06F 3/0484

(57) ABSTRACT

A microgrid human-machine interface (HMI) associated with a microgrid includes one or more memories configured to store energy resource information corresponding to a plurality of energy resource systems, wherein the energy resource information defines a respective plurality of attributes for each energy resource system; a display unit; one or more processors, coupled to the one or more memories, configured to: evaluate the respective plurality of attributes for each energy resource system, automatically group the plurality of energy resource systems into a plurality of groups based on the respective plurality of attributes for each energy resource system, and cause the display unit to display an adaptive graphical user interface (GUI) based on the plurality of groups; and an input interface configured to receive user input for manipulating the adaptive GUI. The adaptive GUI is configured to selectively display the plurality of energy resource systems according to the plurality of groups.

### TECHNICAL FIELD

The present disclosure relates generally to microgrids and, for example, to a scalable modular configuration for a human-machine interface (HMI) of a microgrid.

### BACKGROUND

A microgrid is a self-sufficient energy system that serves a particular geographic area, such as a college campus, a hospital complex, a business center, a neighborhood, a mining site, a drilling site, and/or the like. Within a microgrid are one or more kinds of distributed energy resources (DERs) (e.g., solar panels, wind turbines, fuel cells, photovoltaic (PV) cells, generators, energy storage devices (e.g., batteries, capacitors, etc.), and/or other energy sources) that produce power for the microgrid. Some microgrids are configured as off-grid electrical power distribution systems (e.g., stand-alone microgrids or islands) that do not connect to a larger electrical power distribution system (e.g., a macrogrid) run by, for example, an electric utility or power plant. Some microgrids are able to operate in a grid-connected mode and in a stand-alone mode. In a grid-connected mode, a microgrid may operate connected to and synchronous with the larger electrical power distribution system. In a stand-alone mode, the microgrid may be disconnected from the larger electrical power distribution system and operate as a stand-alone microgrid. A microgrid controller may control whether the microgrid operates in the grid-connected mode or in the stand-alone mode, for example, based on a schedule or based on one or more conditions being satisfied.

Over the years, the complexity of microgrids has increased in terms of a number of assets, asset types, configurable loads, and connections between multiple microgrids. The higher complexity has increased a complexity in configuring site parameters on a human-machine interface (HMI), which often leads to human errors during setup, such as misconfiguration or non-configuration of critical parameters. The increased complexity in configuring site parameters on the HMI may also make it difficult to trace a location to input data in a multi-layered configuration. The higher complexity of microgrids may also make diagnosing a health of the microgrid more difficult, including tracing the locations of errors in a multi-layered configuration. The higher complexity of microgrids may also make monitoring errors or faults and providing corrective actions more difficult due to, for example, a lack of adaptive priority-based loads/assets/microgrids visualization, and a lack of user-based adaptive groupings for microgrid visualization.

China Patent Application CN115525197A discloses a structured HMI design method and a system in the technical field of industrial control, wherein the method comprises the following steps: s10, creating a module set comprising a plurality of functional modules, and setting index numbers, structural groups, functional groups and element groups of the functional modules; step S20, an interface arrangement rule is established; s30, dragging the functional module required to be used by the industrial control equipment to a pre-established interface template through the HMI macroinstruction and the index number; and S40, laying out the function modules on the interface template based on the interface arrangement rule to generate an HMI interface. However, China Patent Application does not disclose modifying parameters of replica device components based on parameters used from primary device components.

The HMI of the present disclosure solves one or more of the problems set forth above and/or other problems in the art.

### SUMMARY

A microgrid HMI associated with a microgrid may include one or more memories configured to store energy resource information corresponding to a plurality of energy resource systems associated with the microgrid, wherein each energy resource system of the plurality of energy resource systems is configured to supply power to the microgrid, and wherein the energy resource information defines a respective plurality of attributes for each energy resource system of the plurality of energy resource systems; a display unit; one or more processors, coupled to the one or more memories, configured to: evaluate the respective plurality of attributes for each energy resource system, automatically group the plurality of energy resource systems into a plurality of groups based on the respective plurality of attributes for each energy resource system; and cause the display unit to display an adaptive GUI based on the plurality of groups, wherein the adaptive GUI is configured to selectively display the plurality of energy resource systems according to the plurality of groups; and an input interface configured to receive user input for manipulating the adaptive GUI.

A method of grouping assets associated with a microgrid may include storing, by an HMI, asset information corresponding to a plurality of assets associated with the microgrid, wherein each asset of the plurality of assets is configured to supply power to the microgrid or sink power from the microgrid, and wherein the asset information defines a respective plurality of attributes for each asset of the plurality of assets; evaluating, by the HMI, the respective plurality of attributes for each asset; automatically grouping, by the HMI, the plurality of assets into a plurality of groups based on the respective plurality of attributes for each asset; and generating an adaptive GUI based on the plurality of groups, wherein the adaptive GUI is configured to selectively display the plurality of assets according to the plurality of groups.

### BRIEF DESCRIPTION OF THE DRAWINGS

FIG. 1 shows a system according to one or more implementations.

FIG. 2 shows a microgrid according to one or more implementations.

FIG. 3 is a flowchart of an example process associated with scalable modular configuration for an HMI.

FIG. 4 is a diagram of example components of the HMI associated with a scalable modular configuration for the HMI.

### DETAILED DESCRIPTION

This disclosure relates to a power distribution system, and is applicable to any system that distributes and/or receives power via a power grid. Some aspects relate to an HMI that is configured to aid in controlling one or more components and/or systems associated with the microgrid, including energy resource systems and/or loads. The HMI may provide an adaptive GUI that may display macrogrid assets and/or loads based on multiple groupings.

A scalable modular configuration of the HMI for microgrid applications provides easy site configuration with pre-defined templates for traditional assets, user-defined templates for non-traditional assets, and user-defined modular blocks for universal site-specific parameters; enabling copying and pasting of loads/assets/configurations/microgrids once configured; enabling modification of replica copies; grouping assets based on type, bus, geo-location, user-defined criteria, and multiple parameters; and providing an adaptive GUI based on user-defined or predefined sequences of asset dispatch. The adaptive GUI may display groupings of similar or non-similar type assets based on user definition (e.g., based on group, type, power output, power consumption, bus level, and/or geo-location, or other user-defined criteria). The adaptive GUI may be adjusted based on user-defined or pre-defined asset dispatch sequences. A visualization of the adaptative GUI may be adapted based on top to bottom levels of groupings, priority of assets/groups, and/or geo-location for flexible asset monitoring. The adaptive GUI may display adaptive groupings based on user definition for multiple microgrid connections. The adaptive GUI may facilitate monitoring and performing diagnostics by providing easy visualization from top to bottom level of groupings, easy visualization of priorities of types, groups, and asset, and easy visualization of site level monitoring based on geo-location. The scalable modular configuration of the HMI may facilitate microgrid configuration, which may minimize human errors, provide faster commissioning of microgrid sites, provide easy and configurable microgrid visualization, and provide faster and more intuitive microgrid diagnostics.

Some features may include copying previously-configured loads, assets, and bus configurations, geo-location configuration, and entire microgrid configurations, and pasting a copied configuration as an editable template for further configuration and customization. Multiple parameters may be used for grouping assets. A GUI layout may be adjusted based on user-defined or predefined asset dispatch sequences.

A method of configuring a microgrid having an HMI may include, by using the HMI, configuring the microgrid by selecting from (i) pre-defined templates, (ii) user-defined templates, and/or (iii) user-defined modular blocks for site-specific parameters.

A method of grouping assets associated with a microgrid may include storing, by an HMI, asset information corresponding to a plurality of assets associated with the microgrid, wherein each asset of the plurality of assets is configured to supply power to the microgrid or sink power from the microgrid, and wherein the asset information defines a respective plurality of attributes for each asset of the plurality of assets; evaluating, by the HMI, the respective plurality of attributes for each asset; automatically grouping, by the HMI, the plurality of assets into a plurality of groups based on the respective plurality of attributes for each asset; and generating an adaptive GUI based on the plurality of groups, wherein the adaptive GUI is configured to selectively display the plurality of assets according to the plurality of groups.

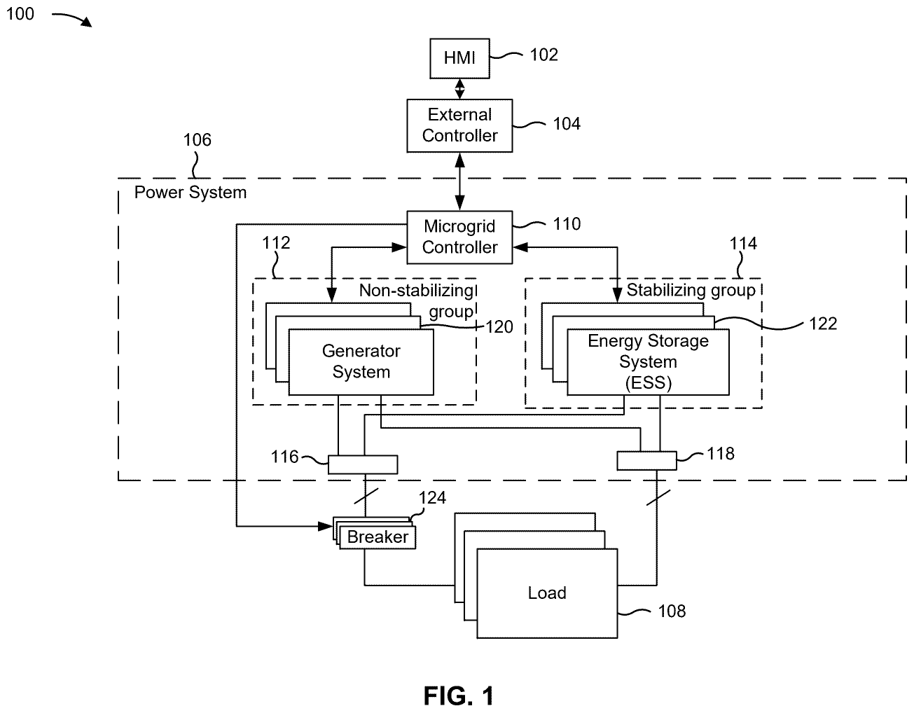

FIG. 1 shows a system 100 according to one or more implementations. The system 100 may include a human-to-machine interface (HMI) 102, an external controller 104, a power system 106, and one or more loads 108.

The power system 106 may be a microgrid or other type of electrical power distribution system that may provide power to the one or more loads 108. In some cases, the power system 106 may be an off-grid electrical power distribution system. In some cases, the power system 106 may be configurable to operate in a grid-connected mode and in a stand-alone mode. The power system 106 may include a microgrid controller 110, a non-stabilizing group of energy resource systems 112 (e.g., a non-stabilizing group of DERs), a stabilizing group of energy resource systems 114 (e.g., a stabilizing group of DERs), and interfaces 116 and 118. Generally, “off-grid” may mean that the electrical power distribution system is not connected to a larger electrical power distribution system run by, for example, an electric utility or other large-scale electric power generation plant that serves electricity to a geographic area, campus, compound, etc. However, techniques disclosed herein may still be applied to electrical power distribution systems that are connected to larger electrical power distribution systems. For instance, the larger electrical power distribution systems may operate as a power source in a primary provider role or secondary provider role, while the power system 106 may operate as a power source in the other of the primary provider role or secondary provider role.

The non-stabilizing group of energy resource systems 112 may include one or more energy generator systems 120. Each energy generator system 120 may include a power generator (e.g., an engine-generator, a fuel cell, a PV cell, or other power generating system) and a local generator controller communicatively coupled to the microgrid controller 110. Thus, each energy generator system 120 may generate power from a respective power source. Each local generator controller may control how much power a respective power generator generates, control a rate of power distribution, and/or obtain status information corresponding to the respective power generator. Each local generator controller may be controlled by the microgrid controller 110.

The stabilizing group of energy resource systems 114 may include one or more energy storage systems (ESSs) 122. Each energy storage system 122 may include an electric storage device (e.g., one or more batteries and/or capacitors) and a local ESS controller communicatively coupled to the microgrid controller 110. Each local ESS controller may control a flow of power into or out of a respective electric storage device, including charging of the respective electric storage device and discharging of the respective electric storage device, control a rate of power flow, and/or obtain status information corresponding to the respective electric storage device, such as state-of-charge (SOC), state-of-health (SOH), discharge limit, and other device parameters. Each local ESS controller may be controlled by the microgrid controller 110.

The system 100 may also include one or more breakers 124 (e.g., distribution breakers or switches) that may be individually controlled by the microgrid controller 110 to connect a respective load 108 to the power system 106 or disconnect the respective load 108 from the power system 106. The one or more breakers 124 may be part of one or both interfaces 116 and 118.

The HMI 102 may include one or more processors, and may be configured to receive and process one or more inputs from a user, such as an operator. Additionally, the HMI 102 may be configured to provide one or more prompts or outputs to the user. Thus, the HMI 102 may be a user terminal configured to interact with a user to process information and/or commands provided by the user, provide information to the user (e.g., status information), and/or perform one or more tasks or functions in response to processing the information and/or commands provided by the user. The HMI 102 may be communicatively coupled to the external controller 104, which may be communicatively coupled to the microgrid controller 110. In some implementations, the HMI 102 may be communicatively coupled directly to the microgrid controller 110. The external controller 104 may send commands to and receive information from the microgrid controller 110. For example, the external controller 104 may send commands to the microgrid controller 110 based on information received from the HMI 102. Thus, the external controller 104 may be a user-commanded controller. The external controller 104 may be integrated with the HMI 102. The external controller 104 may be a controller of a larger electrical power distribution system (e.g., a macrogrid, a power generation plant, and/or electric utility provider).

The power system 106 may provide electrical power to the one or more loads 108. Generally, the power system 106 may provide alternating current (AC) power at a particular voltage and a particular current. The microgrid controller 110 may control one or more energy storage systems 122 to instantaneously inject power when power is needed by the power system 106 or instantaneously absorb surplus power generated by the power system 106. Accordingly, one of more electric storage devices of the energy storage systems 122 may act as a power consumer on one or more energy generator systems 120 or as a power source for the one or more energy generator systems 120, to thereby ensure that system bus frequencies of the non-stabilizing group of energy resource systems 112 are maintained at a nominal value. In other words, the microgrid controller 110 may control the stabilizing group of energy resource systems 114 to stabilize loads of the non-stabilizing group of energy resource systems 112 in order to maintain the non-stabilizing group of energy resource systems 112 at a relatively constant load, which may reduce a recurrence of frequency deviations from the nominal value.

The microgrid controller 110 may be integrated with, or separate from (but connected to), the interfaces 116 and 118, the energy generator systems 120, and the energy storage systems 122, or combinations thereof. In this manner, a user may, through interaction with the HMI 102, add or remove energy generator systems 120 to increase/reduce system power generation and/or add or remove energy storage systems 122 to increase/reduce system energy storage capacity, in accordance with a user's preference. For instance, a user may prefer to add additional energy generator systems 120 and/or add additional energy storage systems 122 to increase load capacity if additional loads 108 are expected to be connected to the power system 106, or remove energy generator systems 120 and/or remove energy storage systems 122 to decrease load capacity if loads 108 are expected to be disconnected from the power system 106. Additionally, the microgrid controller 110 may be configured to add or remove energy generator systems 120 and/or add or remove energy storage systems 122 from the power system 106 based one or more conditions being satisfied. In some cases, the microgrid controller 110 may be configured to add or remove energy generator systems 120 and/or add or remove energy storage systems 122 from the power system 106 based on a schedule.

The one or more loads 108 may be any device that can connect to a power distribution system, such as the power system 106, to receive electrical power. Examples of loads may include heavy machinery (e.g., electric mining machines, haulers, etc.), personal devices, appliances, heating, ventilation, and air conditioning (HVAC) systems, industrial drills, personal residence electrical distribution systems, etc. The loads 108 may include one or more non-stable loads, such as one or more cyclic loads. The loads 108 may include unidirectional loads (e.g., loads that can only receive power from the power system 106), bi-directional loads (e.g., loads that can both receive power from the power system 106 and provide power to the power system 106), charging loads (e.g., loads that include a chargeable electric battery), essential loads (e.g., loads that require uninterrupted service), and/or non-essential loads (e.g., loads that do not require uninterrupted service). Loads may be assigned different priorities based on load type, load classification, and/or operation state or mode.

Generally, the one or more loads 108 may receive the power from the power system 106 and use the power in accordance with the operations of the one or more loads 108. Users of the power system 106 and the one or more loads 108 may connect/disconnect the one or more loads 108 by electrically connecting the one or more loads 108 to the interfaces 116 and 118 of the power system 106. For instance, the interfaces 116 and 118 may have AC plugs/sockets to connect the one or more loads 108 in parallel to the one or more energy generator systems 120 and the one or more energy storage systems 122 of the power system 106. One or more loads 108 may include a local load controller that may collect load information and transmit the load information to the microgrid controller 110. Load information may include information indicating a load type, a load classification, and/or an operation state or mode of a load 108. The loads can be active (real) or reactive to allow for a power quality-based approach to scheduling. Load information may include load data of a load, such as maximum load and minimum load. For chargeable loads, load information may include maximum charging load, maximum state of charge, minimum state of charge, current state of charge, and usable discharge energy as a function of the current state of charge. Load information may be received by the microgrid controller 110 via the interfaces 116 and 118, which may include one or more communication interfaces coupled to the microgrid controller 110.

The interfaces 116 and 118 may also have a plurality of generator connections and a plurality of energy store connections. The plurality of generator connections may be hardwired electrical connections and/or AC plugs/sockets to connect the one or more energy generator systems 120 in parallel to the at least one load 108 and the one or more energy storage systems 122. The plurality of energy store connections may be hardwired electrical connections and/or AC plugs/sockets to connect the one or more energy storage systems 122 in parallel to the one or more loads 108 and the one or more energy generator systems 120. For instance, the power system 106 may or may not allow addition/removal of energy generator systems 120 and/or addition/removal of energy storage systems 122. Therefore, depending on a configuration, the interfaces 116 and 118 may include: (1) hardwired electrical connections that connect the at least one energy generator system 120; (2) AC plugs/sockets to connect/disconnect the at least one energy generator system 120; (3) hardwired electrical connections that connect the at least one energy storage system 122; and/or (4) AC plugs/sockets to connect/disconnect the at least one energy storage system 122. The interfaces 116 and 118 may be coupled to a system bus (e.g., a power bus) of the power system 106. The system bus may enable one of more of the energy storage systems 122 to absorb power from one or more energy generator systems 120 and/or one or more loads 108 (e.g., for charging and/or storing power).

The one or more energy generator systems 120 may also include communication interfaces. The communication interfaces of the one or more energy generator systems 120 may enable the one or more energy generator systems 120 to communicate with the microgrid controller 110. For instance, the one or more energy generator systems 120 may be connected to the microgrid controller 110 by wired or wireless communication. The one or more energy generator systems 120 may provide the microgrid controller 110 with generator data (e.g., energy resource information). The generator data, for each of the one or more energy generator systems 120, may include load data and/or generator parameters. The load data may include a current (e.g., instantaneous) load seen by the one or more energy generator systems 120 and/or past load data (if one or more energy generator systems 120 store such data locally). The current load/past load data may include voltage (e.g., in volts) and/or current (e.g., in amperes) measured by one or more sensor components included in an energy generator system 120. The generator parameters may include a generator set maximum threshold value and a generator set minimum threshold value. Alternatively, to reduce transmission bandwidth, the generator data may omit the generator parameters, and the one or more energy generator systems 120 may transmit the generator parameters during an initial configuration process between the one or more energy generator systems 120 and the microgrid controller 110. The generator set maximum threshold value and the generator set minimum threshold value may indicate a maximum power load and a minimum power load, respectively, that a generator of an energy generator system 120 may support.

The one or more energy storage systems 122 may be any energy storage device that can store and output AC power. For instance, the one or more energy storage systems 122 may include at least one electrical-chemical energy storage (e.g., a battery), electrical energy storage (e.g., a capacitor, a supercapacitor, or a superconducting magnetic energy storage), mechanical energy storage (e.g., a fly wheel, a pump system), and/or any combination thereof. The one or more energy storage systems 122 may include inverters (individually or collectively) so that the one or more energy storage systems 122 may operate as a power consumer or a power source. The one or more energy storage systems 122 may also include electronic control mechanisms to control (1) how much load the one or more energy storage systems 122 draw, or (2) how much AC power the one or more energy storage systems 122 output.

The one or more energy storage systems 122 may also include communication interfaces. The communication interfaces of the one or more energy generator systems 120 may enable the one or more energy storage systems 122 to communicate with the microgrid controller 110. For instance, the one or more energy storage systems 122 may be connected to the microgrid controller 110 by wired or wireless communication. The one or more energy storage systems 122 may provide the microgrid controller 110 with energy storage data (e.g., energy resource information) and may receive instructions from the microgrid controller 110.

The energy storage data may include, for each of the at least one energy store, a current energy level (e.g., kilowatt-hours currently stored), total energy storage capacity (e.g., kilowatt-hours of capacity), and/or discharge/charge parameters. The current energy level may be measured by a battery meter of an energy storage. The battery meter may one or combinations of a voltmeter, an amp-hour meter, and/or an impedance-based meter. The discharge/charge parameters may indicate an amount of discharge power and an amount of charge power for a respective energy storage device of the one or more energy storage systems 122. Alternatively, to reduce transmission bandwidth, the energy storage data may omit the discharge/charge parameters, and the one or more energy storage systems 122 may transmit the discharge/charge parameters when the one or more energy storage systems 122 are first connected to the microgrid controller 110.

The one or more energy storage systems 122 may receive requests (e.g., instructions) for the energy storage data to provide the energy storage data and/or continuously provide the energy storage data to the microgrid controller 110. The instructions may include energy storage dispatch (ESD) instructions. An ESD instruction may include an instruction to inject power to a system bus of the power system 106 or absorb power from the system bus of the power system 106. ESD instructions may be provided in control signals (e.g., communication signals that provide the ESD instructions). At least one ESD instruction may be utilized to rapidly stabilize the load, thereby stabilizing the bus frequency of the power system 106 in a time efficient manner, rather than attempting to stabilize the load using the one or more energy generator systems 120 alone. The one or more energy storage systems 122 may control the inverters and the electronic control mechanisms to control (1) quantity of load drawn by the one or more energy storage systems 122, or (2) the amount of AC power output produced by the one or more energy storage systems 122, in accordance with the ESD instructions. Reactive and/or active may be used as a qualifier for loads, where reactive loads may contribute to a stabilization algorithm in addition to the active or real loads.

The microgrid controller 110 may include at least one memory device (e.g., one or more memories) for storing instructions (e.g., program code); at least one processor for executing the instructions from the memory device to perform a set of desired operations; and a communication interface (e.g., coupled to a communication bus) for facilitating the communication between various system components. The instructions may be computer-readable instructions for executing a control application. The communication interface of the microgrid controller 110 may enable the microgrid controller 110 to communicate with the one or more energy generator systems 120 and the one or more energy storage systems 122. The microgrid controller 110, while executing the control application, may receive the generator data and the energy storage data (e.g., energy resource information), process the generator data and the energy storage data to generate one or more ESD instructions, and output the ESD instructions to one or more energy generator systems 120 and/or to one or more energy storage systems 122.

To process the generator data and the energy storage data to generate the ESD instructions, the control application may include a load stabilization function and/or an SOC function. The control application may also include a generator set limit function and/or energy store discharge/charge limit function to generate the ESD instructions. In some cases, the load stabilization function may be activated while the power system 106 is configured in stand-alone mode in order to provide off-grid load stabilization. The microgrid controller 110 may automatically activate or deactivate the aforementioned system functions based on presence or absence of systems parameters (such as no generator set minimum threshold value is available, etc.) or one or more system conditions being satisfied.

Generally, the load stabilization function may ensure that system bus frequencies of the one or more energy generator systems 120 are maintained at a nominal value by causing an amount of power to be absorbed/injected by the one or more energy storage systems 122. The amount of power may be determined based on a difference from an instantaneous load and a moving average of the load. Meanwhile, the SOC function may ensure that the one or more energy storage systems 122 are charged to a target SOC or a target SOC range such that a SOC of one or more energy storage systems does not drift too low or too high, outside of a desired operating range (e.g., the target SOC range). The target SOC or the target SOC range may enable the at least one energy storage system 122 to provide long term beneficial use to the system 100, such as having a range of operation usable by the power system 106 and/or avoid degradation ranges of the one or more energy storage systems 122.

Furthermore, the systems and methods of the present disclosure may check the ESD instruction against acceptable generator maximum/minimum loads of the one or more energy generator systems 120 and the discharge/charge limits of the one or more energy storage systems 122, so as to safely operate the one or more energy generator systems 120.

One or more energy generator systems 120 may include an engine-generator that provides AC power to the power system 106, which may provide the AC power to the at least one load 108. Generally, an engine-generator may be any device that converts motive power (mechanical energy) into electrical power to output the AC power. An engine-generator may be a gas turbine electrical generator. In such gas turbine electrical generators, fast changes in load from the at least one load 108 may cause a system bus frequency to deviate from a nominal value. The system bus frequency may be a frequency of electrical components of the generator. For instance, such gas turbine electrical generators may have isochronous frequency control governors that may try to maintain the system bus frequency to the nominal value in response to changes of the load of the one or more loads 108. Therefore, during a transient load charge (e.g., a load transient), the system bus frequency may change as the load on the engine-generator changes. However, a rate of return of the system bus frequency back to the nominal value is slower than a desired rate due to an inertia of motion of physical components (e.g., a rotor of a stator-rotor) of the engine-generator. The slow rate of return may reduce power quality of the power system 106. The power quality of the power system 106 may be determined based on the voltage, frequency, and waveform of the power output to the one or more loads 108. A high power quality may ensure continuity of service for the one or more loads 108, such that the one or more loads 108 are able to properly function as intended. A low power quality may cause the one or more loads 108 to malfunction, fail prematurely, or not operate at all.

Therefore, avoiding load transients may be beneficial in providing better power quality. However, generally, controlling a load of the one or more loads 108 may not be possible or desirable. Instead, the microgrid controller 110 may control the one or more energy storage systems 122 of the stabilizing group of energy resource systems 114 to act as a power consumer or as an energy source, so that the one or more energy generator systems 120 of the non-stabilizing group of energy resource systems 112 may maintain the system bus frequency at the nominal value, thereby ensuring better power quality.

The microgrid controller 110 may control the one or more energy storage systems 122 to act as a near instantaneous load or energy source, so that the one or more energy generator systems 120 may maintain the system bus frequency at the nominal value, thereby ensuring better power quality. In one aspect of this disclosure, the microgrid controller 110 may control the one or more energy storage systems 122 to instantaneously inject power when power is needed by the at least one load 108 or instantaneously absorb surplus power generated by the one or more energy generator systems 120. Accordingly, the microgrid controller 110 regulates the power supply such that an exact amount of desired power supply flows in or out of the power system 106 at any given time. The instantaneous injecting/absorbing power may be performed to control the amount of transient load seen by the power system 106 and thus stabilize the load and resulting system bus frequency of the one or more energy generator systems 120. The desired power may be calculated by performing a moving average of a system load and then taking a difference of the moving average and an instantaneous load value. This difference may be the desired power output/absorbed of the energy store. Causing the one or more energy storage systems 122 to output/absorb the desired power (e.g., by transmitting the energy storage dispatch instructions) may limit the transient load seen by the one or more energy generator systems 120.

The HMI 102 may include one or more memories configured to store energy resource information corresponding to a plurality of energy resource systems (e.g., DERs, such as energy generator systems 120 and energy storage systems 122) associated with the power system 106 (e.g., a microgrid). Each energy resource system may supply power to the power system 106. In addition, the energy resource information may define a respective plurality of attributes for each energy resource system. For example, a respective plurality of attributes may identify an asset type of a respective energy resource system, a power bus (or bus level) to which the respective energy resource system is connected within the microgrid, a geo-location at which the respective energy resource system is located within the microgrid, and/or a power rating of the respective energy resource system. The asset type may be one of an engine-generator system, an energy storage system, a wind turbine system, a fuel cell system, or a photovoltaic system. Each energy resource system may be connected to a respective power bus (or bus level) of a plurality of power buses (or a plurality of bus levels) in the microgrid. Each energy resource system may be located in a respective geo-location within the microgrid. Each energy resource system may have a respective power rating. A respective power rating may correspond to at least one of a maximum output power, an apparent power, or a minimum operating power factor.

The HMI 102 may include a display unit, such as a display screen. The HMI 102 may include one or more processors, coupled to the one or more memories, configured to evaluate the respective plurality of attributes for each energy resource system. The one or more processors may automatically group the plurality of energy resource systems into a plurality of groups based on the respective plurality of attributes for each energy resource system. The one or more processors may cause the display unit to display an adaptive GUI based on the plurality of groups. The adaptive GUI may be configured to selectively display the plurality of energy resource systems according to the plurality of groups.

The HMI 102 may include an input interface (e.g., at least one input component) configured to receive user input for manipulating the adaptive GUI. An input component may be a keyboard, a mouse, a touch screen, or any other device configured to receive user input and relay the user input to the one or more processors.

The one or more processors of the HMI 102 may automatically update the plurality of groups based on an energy resource system being added to or subtracted from the plurality of energy resource systems associated with the microgrid. Thus, the one or more processors of the HMI 102 may adapt or reconfigure the groupings and the adaptive GUI based on an energy resource system being added to or subtracted from the microgrid.

The plurality of groups may include a plurality of asset type groups, with each asset type group corresponding to a different asset type. The one or more processors of the HMI 102 may automatically group the plurality of energy resource systems into the plurality of asset type groups based on asset types associated with the plurality of energy resource systems, respectively.

The plurality of groups may include a plurality of power bus groups, with each power bus group corresponding to a different power bus of the plurality of power buses. The one or more processors of the HMI 102 may automatically group the plurality of energy resource systems into the plurality of power bus groups based on power buses associated with the plurality of energy resource systems, respectively.

The plurality of groups may include a plurality of geo-location groups, with each geo-location group corresponding to a different localized area of the microgrid. The one or more processors of the HMI 102 may automatically group the plurality of energy resource systems into the plurality of geo-location groups based on geo-locations associated with the plurality of energy resource systems, respectively.

The plurality of groups may include a plurality of power rating groups, with each power rating group corresponding to a different power rating or a different power rating range. The one or more processors of the HMI 102 may automatically group the plurality of energy resource systems into the plurality of power rating groups based on power ratings associated with the plurality of energy resource systems, respectively.

The plurality of groups may include a plurality of output power groups, with each output power group corresponding to a different range of output power being supplied to the microgrid. The one or more processors of the HMI 102 may monitor a real-time output power of each energy resource system (e.g., based on information received from the microgrid controller 110), and automatically group the plurality of energy resource systems into the plurality of output power groups based on real-time output powers associated with the plurality of energy resource systems, respectively.

The one or more processors of the HMI 102 may dynamically assign a priority level in a tiered priority scheme to each energy resource system of the plurality of energy resource systems. The plurality of groups may include a plurality of priority level groups, with each priority level group corresponding to a different priority level. The one or more processors of the HMI 102 may automatically group the plurality of energy resource systems into the plurality of priority level groups based on priority levels associated with the plurality of energy resource systems, respectively.

The one or more memories of the HMI 102 may store a schedule comprising a plurality of time segments in which an operating mode of the microgrid is defined. The operating mode may be a grid-connected mode, a stand-alone mode, a reliability mode, an economy mode, or another type of mode. The one or more processors of the HMI 102 may monitor a current operating mode indicated in a current time segment of the schedule, and dynamically assign the priority levels to the plurality of energy resource systems based on the current operating mode. The one or more processors of the HMI 102 may automatically group the plurality of energy resource systems into the plurality of priority level groups as the priority levels change. The priority levels of energy resource systems and/or loads may change based on operating mode.

The input interface of the HMI 102 may receive input variables for a plurality of attributes based on user input. The one or more processors of the HMI 102 are configured to filter the plurality of energy resource systems based on the input variables and the plurality of groups, and adapt the adaptive GUI to display a filtered group of energy resource systems. For example, the input variables may specify a particular asset type, a particular power bus (or particular bus level), a particular geo-location, a particular power rating, a particular output power or output power range, a particular operation mode (e.g., off/on, charging/discharging, curtailed), and/or other user-defined criteria, such as priority level. The one or more processors of the HMI 102 may cause the adaptive GUI to display groupings of assets that satisfy the input variables.

Additionally, or alternatively, one or more memories of the HMI 102 may store load information corresponding to a plurality of loads associated with the microgrid. Each load may sink power from the microgrid. The load information may define a respective plurality of load attributes for each load. The one or more processors of the HMI 102 may evaluate the respective plurality of load attributes for each load, and automatically group the plurality of loads into a plurality of load groups based on the respective plurality of load attributes for each load. The one or more processors of the HMI 102 may cause the display unit to display the adaptive GUI based on the plurality of load groups. The adaptive GUI may selectively display the plurality of loads according to the plurality of load groups.

The one or more memories of the HMI 102 may store a plurality of attribute templates, including an attribute template for each energy resource system. Each attribute template may define the respective plurality of attributes for a respective energy resource system. The one or more processors of the HMI 102 may analyze the plurality of attribute templates and parse the plurality of energy resource systems into the plurality of groups based on attributes that are defined in the plurality of attribute templates.

The one or more memories of the HMI 102 may store a predefined template of an asset type and an editable template of the asset type. An editable template may be a replica or a copy of a predefined template. A predefined template may include a plurality of fixed attribute fields that include preconfigured attribute values for the asset type. The preconfigured attribute values that are included in the plurality of fixed attribute fields are fixed. In contrast, an editable template may include a plurality of editable attribute fields that include the preconfigured attribute values for the asset type. The preconfigured attribute values that are included in the plurality of editable attribute fields are editable. The one or more processors of the HMI 102 may finalize attribute values in the plurality of editable attribute fields based on user input and store the editable template as one of the plurality of attribute templates. As a result of an editable template being a replica or a copy of a predefined template, human errors, such as misconfiguration or non-configuration of critical parameters, may be reduced or prevented during setup. The one or more processors of the HMI 102 may receive a selection (e.g., from user input) of either the predefined template or the editable template to use for a respective energy resource system.

The one or more processors of the HMI 102 may duplicate a first microgrid configuration to generate a second microgrid configuration, and store the second microgrid configuration in the one or more memories of the HMI 102. The second microgrid configuration may be an editable replica of the first microgrid configuration. A microgrid configuration may be a power bus configuration, including assets connected to a particular power bus, a geo-location configuration, including assets located in a particular geo-location, or an entire microgrid configuration, including all assets associated with the entire microgrid. As a result of an editable microgrid configuration being a replica or a copy of a previous microgrid configuration, human errors, such as misconfiguration or non-configuration of critical parameters, may be reduced or prevented during setup.

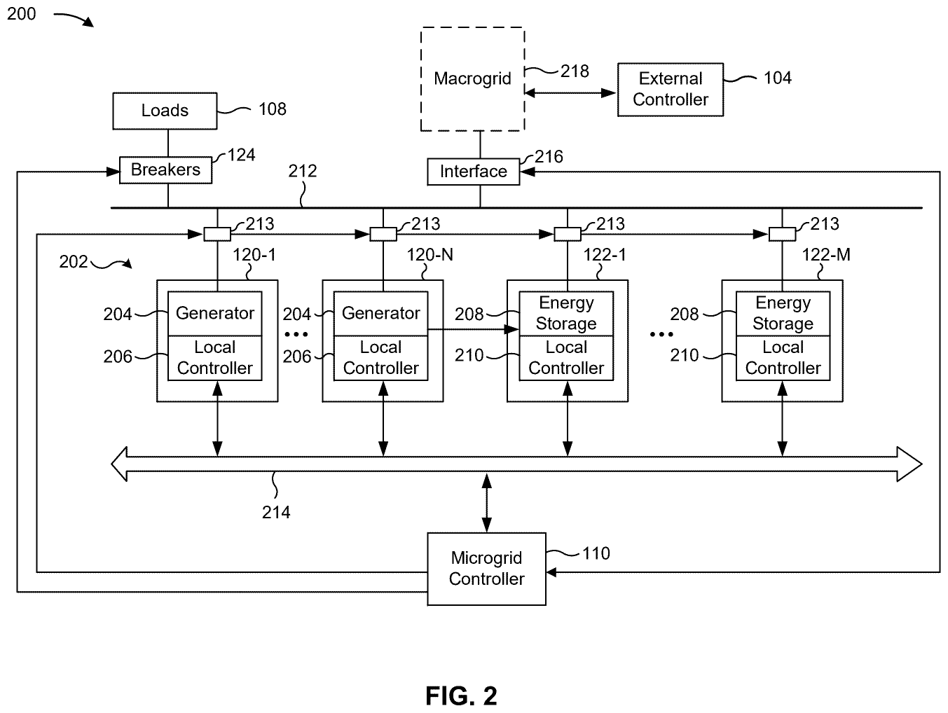

FIG. 2 shows a microgrid 200 according to one or more implementations. The microgrid 200 may be an example of the power system 106 described in connection with FIG. 1. The microgrid 200 may include a plurality of DERs 202. The plurality of DERs 202 may include N energy generator systems 120 and M energy storage systems 122, where N and M are integers greater than zero. For example, the plurality of DERs 202 may include a first energy generator system 120-1 and an N^{th} energy generator system 120-N. Additionally, the plurality of DERs 202 may include a first energy storage system 122-1 and an M^{th} energy storage system 122-M. Each energy generator system 120 may include a power generator 204 and a local generator controller 206. Each energy storage system 122 may include an electric storage device 208 (e.g., one or more batteries and/or capacitors) and a local ESS controller 210.

Each energy generator system 120 may be coupled to a power bus 212 for providing power to one or more loads connected to the power bus 212. Additionally, each energy storage system 122 may be coupled to the power bus 212 for providing power to or absorbing power from the power bus 212 (e.g., for providing power to or absorbing power from one or more components, such as one or more loads and/or one or more energy generator systems 120 connected to the power bus 212).

The microgrid 200 may also include the microgrid controller 110 that is communicatively coupled to the local controllers (e.g., local generator controllers 206 and local ESS controllers 210) of each DER 202 across a communication bus 214. The communication bus 214 may also enable the microgrid 200 to communicate with one or more loads and/or one or more load management systems (e.g., charging systems, fleet management systems, local load controllers, etc.). In some cases, two or more communication buses 214 may be provided. For example, one communication bus may be provided to communicate with local controllers and another communication bus may be provided to communicate with one or more loads and/or one or more load management systems.

Each local generator controller 206 may include any appropriate hardware, software, and/or firmware to sense and control a respective power generator 204, and send information to, and receive information from, microgrid controller 110. For example, a local generator controller 206 may be configured to sense, determine, and/or store generator data of its respective power generator 204. The generator data may be sensed, determined, and/or stored in any conventional manner. Each local generator controller 206 may control whether a respective power generator 204 is connected to or disconnected from the power bus 212 (for example, based on an instruction or a control signal received from the microgrid controller 110).

Each local ESS controller 210 may include any appropriate hardware, software, and/or firmware to sense and control a respective electric storage device 208, and send information to, and receive information from, microgrid controller 110. For example, a local ESS controller 210 may be configured to sense, determine, and/or store various characteristics of its respective electric storage device 208. Such characteristics of the respective electric storage device 208 may include, among others, a current SOC, a current energy, an SOC minimum threshold, an SOC maximum threshold, and a discharge limit of the respective electric storage device 208. These characteristics of each respective electric storage device 208 may be sensed, determined, and/or stored in any conventional manner. Each local ESS controller 210 may control whether a respective electric storage device 208 is connected to or disconnected from the power bus 212 (for example, based on an instruction or a control signal received from the microgrid controller 110).

The microgrid controller 110 may receive or determine a need for charging or discharging of power from the microgrid 200, and may be configured to determine and send signals to allocate a total charge request and/or total discharge request across all of the plurality of DERs 202.

When performing the power allocation functions, the microgrid controller 110 may allocate a certain amount of power from each energy generator system 120 to one or more loads 108. The one or more loads 108 may be connected to the power bus 212 via one or more breakers 124 to receive power from the power bus. When performing the power allocation functions, the microgrid controller 110 may allocate a total charge request and/or a total discharge request across the energy storage systems 122 as a function of a usable energy capacity of each energy storage system 122. The usable energy capacity corresponds to the capacity or amount of energy that an energy storage system 122 can receive in response to a total charging request (usable charge energy), or the capacity or amount of energy that an energy storage system can discharge in response to a total discharge request (usable discharge energy). The usable charge energy is a function of a maximum state of charge, current state of charge, and current energy of the energy storage system, and the usable discharge energy is a function of a minimum state of charge, and current energy of the energy storage system 122. The microgrid controller 110 may determine a usable charge/discharge capacity of each energy storage system 122 (e.g., SOC), a desired charge/discharge of each energy storage system 122, a remainder power of each energy storage system 122, and/or an SOH of each energy storage system 122.

Thus, the microgrid controller 110 regulates a power supply of the microgrid 200 such that an exact amount of desired power flows into or out of the power system 106 at any given time. The microgrid controller 110 may regulate the power supply of the microgrid 200 in cooperation with the local generator controllers 206 and the local ESS controllers 210. The microgrid controller 110 may transmit control signals (e.g., instructions) to the local generator controllers 206 and the local ESS controllers 210 to activate (e.g., to bring online), deactivate (to bring offline), or curtail (limit or regulate to a target output) one or more of the DERs 202. Additionally, or alternatively, the microgrid controller 110 may transmit control signals to one or more switches 213 to control a switch state (e.g., an on state or an off state) of the one or more switches 213, for example, to connect one or more DERs 202 to or disconnect one or more DERs 202 from the microgrid 200 (e.g., the power bus 212). The switches 213 may be integrated in one or both interfaces 116 and 118 described in connection with FIG. 1.

In some cases, two or more power buses 212 may be provided. For example, a power bus may be provided to couple one or more power generators 204 to one or more electric storage devices 208 for charging the one or more electric storage devices 208. For example, the microgrid controller 110 may selectively couple a power generator 204 to an electric storage device 208 to charge the electric storage device 208. Thus, the power bus 212 may be part of a power distribution network of the microgrid 200 that may include one or more power buses used to distribute power between loads 108 and/or DERs 202.

The microgrid 200 may include an interface 216 for connecting the microgrid 200 to and disconnecting the microgrid 200 from an electrical power distribution system 218, such as a macrogrid. The electrical power distribution system 218 may include the external controller 104 (e.g., a macrogrid controller), as described in connection with FIG. 1. The external controller 104 may be coupled to the interface 216 for transmitting control signals, such as instructions or requests, to the microgrid controller 110. The interface 216 may include one or more electrical connections used for connecting the microgrid 200 to the electrical power distribution system 218. The interface 216 may include one or more switches or breakers that are controlled by the microgrid controller 110 for connecting the microgrid 200 to and disconnecting the microgrid 200 from the electrical power distribution system 218. For example, the one or more switches or breakers of the interface 216 may connect the power bus 212 (or another system bus) to or disconnect the power bus 212 (or another system bus) from the electrical power distribution system 218. Thus, the microgrid controller 110 may configure the microgrid 200 to operate in a grid-connected mode by connecting the microgrid 200 to the electrical power distribution system 218 or in a stand-alone mode by disconnecting the microgrid 200 from the electrical power distribution system 218.

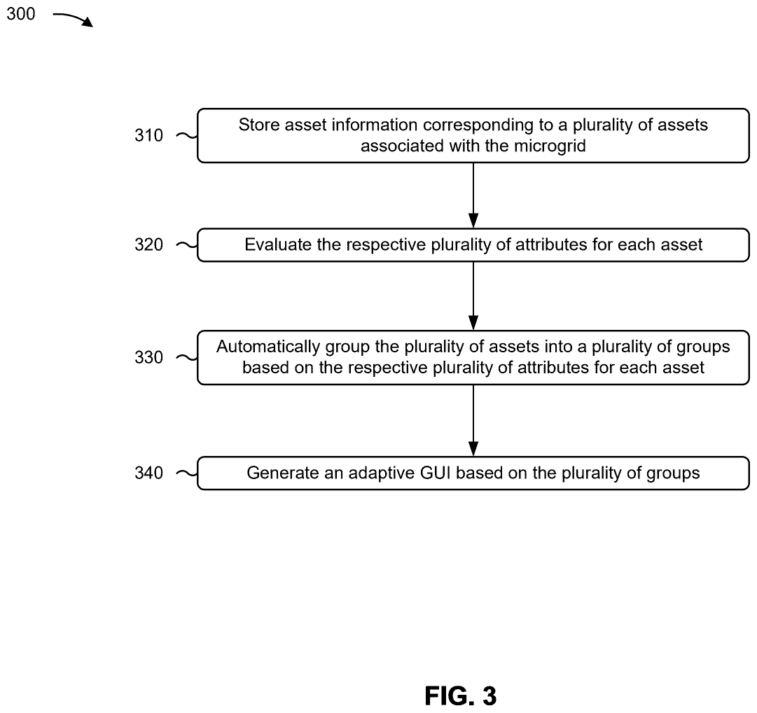

FIG. 3 is a flowchart of an example process 300 associated with scalable modular configuration for an HMI. One or more process blocks of FIG. 3 may be performed by an HMI (e.g., HMI 102). Additionally, or alternatively, one or more process blocks of FIG. 3 may be performed by another device or a group of devices separate from or including the HMI, such as another device or component that is internal or external to the HMI, such as external controller 104 and/or microgrid controller 110.

As shown in FIG. 3, process 300 may include storing asset information corresponding to a plurality of assets associated with the microgrid, wherein each asset of the plurality of assets is configured to supply power to the microgrid or sink power from the microgrid, and wherein the asset information defines a respective plurality of attributes for each asset of the plurality of assets (block 310). For example, the HMI 102 may store asset information corresponding to a plurality of assets associated with the microgrid, wherein each asset of the plurality of assets is configured to supply power to the microgrid or sink power from the microgrid, and wherein the asset information defines a respective plurality of attributes for each asset of the plurality of assets, as described above.

As further shown in FIG. 3, process 300 may include evaluating the respective plurality of attributes for each asset (block 320). For example, the HMI 102 may evaluate the respective plurality of attributes for each asset, as described above.

As further shown in FIG. 3, process 300 may include automatically grouping the plurality of assets into a plurality of groups based on the respective plurality of attributes for each asset (block 330). For example, the HMI 102 may automatically group the plurality of assets into a plurality of groups based on the respective plurality of attributes for each asset, as described above.

As further shown in FIG. 3, process 300 may include generating an adaptive GUI based on the plurality of groups, wherein the adaptive GUI is configured to selectively display the plurality of assets according to the plurality of groups (block 340). For example, the HMI 102 may generate an adaptive GUI based on the plurality of groups, wherein the adaptive GUI is configured to selectively display the plurality of assets according to the plurality of groups, as described above.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

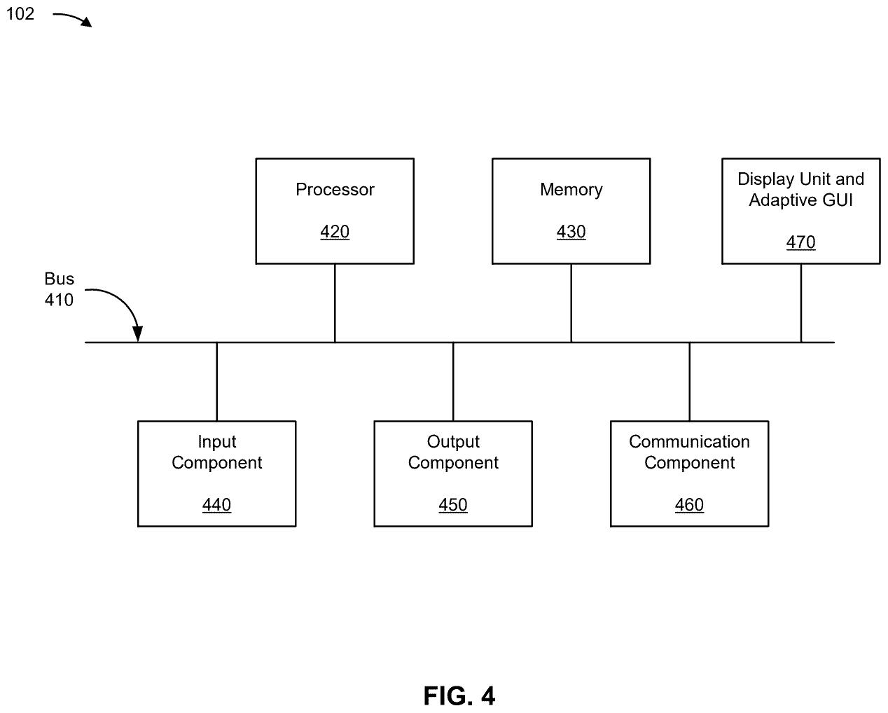

FIG. 4 is a diagram of example components of the HMI 102 associated with a scalable modular configuration for the HMI 102. The HMI 102 may include a bus 410, a processor 420, a memory 430, an input component 440, an output component 450, a communication component 460, and/or a display unit 470 with an adaptive GUI.

The bus 410 may include one or more components that enable wired and/or wireless communication among the components of the HMI 102. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus.

The processor 420 may include a central processing unit a microprocessor, a controller, a microcontroller, a digital signal processor, a field-programmable gate array, an application-specific integrated circuit, and/or another type of processing component. The processor 420 may be implemented in hardware, firmware, or a combination of hardware and software. The processor 420 may include one or more processors capable of being programmed to perform one or more operations or processes described elsewhere herein.

The memory 430 may store information, one or more instructions, and/or software (e.g., one or more software applications) related to the operation of the HMI 102. The memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the HMI 102 to receive input, load information, generator data, energy storage data, status information, scheduling information, and/or control inputs (e.g., control inputs from a user). The output component 450 may enable the HMI 102 to provide output, such as one or more control signals, asset information (e.g., asset parameters), system information (e.g., system parameters), status information, scheduling information, priority information, and/or override information, to a microgrid controller for controlling loads, energy storage systems, breakers, switches, and other components associated with the microgrid described herein. The communication component 460 may enable the HMI 102 to communicate with other devices via a wired connection and/or a wireless connection. For example, the communication component 460 may include a receiver, a transmitter, and/or a transceiver.

The display unit 470 (e.g., a display screen) may be configured to display the adaptive GUI. The GUI may selectively display a plurality of energy resource systems according to a plurality of groups based on user input received by the input component 440. The processor 420 may cause the display unit 470 to display the adaptive GUI, and may adapt the adaptive GUI based on user input and/or the plurality of groups formed by the processor 420.

The HMI 102 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. Execution of the set of instructions, by one or more processors 420, may cause the one or more processors 420 and/or the HMI 102 to perform one or more operations or processes described herein. Hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

### INDUSTRIAL APPLICABILITY

A scalable modular configuration of the HMI for microgrid applications provides easy site configuration with pre-defined templates for traditional assets, user-defined templates for non-traditional assets, and user-defined modular blocks for universal site-specific parameters; enabling copying and pasting of loads/assets/configurations/microgrids once configured; enabling modification of replica copies; grouping assets based on type, bus, geo-location, user-defined criteria, and multiple parameters; and providing an adaptive GUI based on user-defined or predefined sequences of asset dispatch. The adaptive GUI may display groupings of assets of similar or non-similar type assets based on user definition (e.g., based on group, type, power output, power consumption, bus level, and/or location). The adaptive GUI may display adaptive groupings based on user definition for multiple microgrid connections. The adaptive GUI may facilitate monitoring and performing diagnostics by providing easy visualization from top to bottom level of groupings, easy visualization of priorities of types, groups, and asset, and easy visualization of site level monitoring based on geo-location. The scalable modular configuration of the HMI may facilitate microgrid configuration, which may minimize human errors, provide faster commissioning of microgrid sites, provide easy and configurable microgrid visualization, and provide faster and more intuitive microgrid diagnostics.

What is claimed is:

1. A microgrid human-machine interface (HMI) associated with a microgrid, comprising:
one or more memories configured to store energy resource information corresponding to a plurality of energy resource systems associated with the microgrid, wherein each energy resource system of the plurality of energy resource systems is configured to supply power to the microgrid, and wherein the energy resource information defines a respective plurality of attributes for each energy resource system of the plurality of energy resource systems;
a display unit;
one or more processors, coupled to the one or more memories, configured to:
evaluate the respective plurality of attributes for each energy resource system,
automatically group the plurality of energy resource systems into a plurality of groups based on the respective plurality of attributes for each energy resource system; and
cause the display unit to display an adaptive graphical user interface (GUI) based on the plurality of groups, wherein the adaptive GUI is configured to selectively display the plurality of energy resource systems according to the plurality of groups; and
an input interface configured to receive user input for manipulating the adaptive GUI.

2. The microgrid HMI of claim 1, wherein the one or more processors are configured to automatically update the plurality of groups based on an energy resource system being added to or subtracted from the plurality of energy resource systems associated with the microgrid.

3. The microgrid HMI of claim 1, wherein the respective plurality of attributes identify an asset type of a respective energy resource system, a power bus to which the respective energy resource system is connected within the microgrid, a geo-location at which the respective energy resource system is located within the microgrid, and a power rating of the respective energy resource system.

4. The microgrid HMI of claim 3, wherein the asset type is one of an engine-generator system, an energy storage system, a wind turbine system, a fuel cell system, or a photovoltaic system.

5. The microgrid HMI of claim 1, wherein the plurality of groups include a plurality of asset type groups, with each asset type group corresponding to a different asset type, and
wherein the one or more processors are configured to automatically group the plurality of energy resource systems into the plurality of asset type groups based on asset types associated with the plurality of energy resource systems, respectively.

6. The microgrid HMI of claim 1, wherein each energy resource system is connected to a respective power bus of a plurality of power buses in the microgrid,
wherein the plurality of groups include a plurality of power bus groups, with each power bus group corresponding to a different power bus of the plurality of power buses, and
wherein the one or more processors are configured to automatically group the plurality of energy resource systems into the plurality of power bus groups based on power buses associated with the plurality of energy resource systems, respectively.

7. The microgrid HMI of claim 1, wherein each energy resource system is located in a respective geo-location within the microgrid,
wherein the plurality of groups include a plurality of geo-location groups, with each geo-location group corresponding to a different localized area of the microgrid, and
wherein the one or more processors are configured to automatically group the plurality of energy resource systems into the plurality of geo-location groups based on geo-locations associated with the plurality of energy resource systems, respectively.

8. The microgrid HMI of claim 1, wherein each energy resource system has a respective power rating,
wherein the plurality of groups include a plurality of power rating groups, with each power rating group corresponding to a different power rating or a different power rating range, and
wherein the one or more processors are configured to automatically group the plurality of energy resource systems into the plurality of power rating groups based on power ratings associated with the plurality of energy resource systems, respectively.

9. The microgrid HMI of claim 8, wherein the respective power rating corresponds to at least one of a maximum output power, an apparent power, or a minimum operating power factor.

10. The microgrid HMI of claim 1, wherein the plurality of groups include a plurality of output power groups, with each output power group corresponding to different range of output power being supplied to the microgrid,
wherein the one or more processors are configured to monitor a real-time output power of each energy resource system, and automatically group the plurality of energy resource systems into the plurality of output power groups based on real-time output powers associated with the plurality of energy resource systems, respectively.

11. The microgrid HMI of claim 1, wherein the plurality of groups include a plurality of asset type groups, with each asset type group corresponding to a different asset type,
wherein each energy resource system is connected to a respective power bus of a plurality of power buses in the microgrid,
wherein the plurality of groups include a plurality of power bus groups, with each power bus group corresponding to a different power bus of the plurality of power buses,
wherein each energy resource system is located in a respective geo-location within the microgrid,
wherein the plurality of groups include a plurality of geo-location groups, with each geo-location group corresponding to a different localized area of the microgrid,
wherein each energy resource system has a respective power rating,
wherein the plurality of groups include a plurality of power rating groups, with each power rating group corresponding to a different power rating or a different power rating range,
wherein the one or more processors are configured to automatically group the plurality of energy resource systems into the plurality of asset type groups based on asset types associated with the plurality of energy resource systems, respectively,
wherein the one or more processors are configured to automatically group the plurality of energy resource systems into the plurality of power bus groups based on power buses associated with the plurality of energy resource systems, respectively,
wherein the one or more processors are configured to automatically group the plurality of energy resource systems into the plurality of geo-location groups based on geo-locations associated with the plurality of energy resource systems, respectively, and
wherein the one or more processors are configured to automatically group the plurality of energy resource systems into the plurality of power rating groups based on power ratings associated with the plurality of energy resource systems, respectively.

12. The microgrid HMI of claim 11, wherein the input interface is configured to receive input variables for a plurality of attributes, and
wherein the one or more processors are configured to filter the plurality of energy resource systems based on the input variables and the plurality of groups, and adapt the adaptive GUI to display a filtered group of energy resource systems.

13. The microgrid HMI of claim 1, wherein the one or more processors are configured to dynamically assign a priority level in a tiered priority scheme to each energy resource system of the plurality of energy resource systems,
wherein the plurality of groups include a plurality of priority level groups, with each priority level group corresponding to a different priority level, and
wherein the one or more processors are configured to automatically group the plurality of energy resource systems into the plurality of priority level groups based on priority levels associated with the plurality of energy resource systems, respectively.

14. The microgrid HMI of claim 13, wherein the one or more memories are configured to store a schedule comprising a plurality of time segments in which an operating mode of the microgrid is defined, and
wherein the one or more processors are configured to monitor a current operating mode indicated in a current time segment of the schedule, and dynamically assign the priority levels to the plurality of energy resource systems based on the current operating mode.

15. The microgrid HMI of claim 1, wherein the one or more memories are configured to store load information corresponding to a plurality of loads associated with the microgrid, wherein each load of the plurality of loads is configured to sink power from the microgrid, and wherein the load information defines a respective plurality of load attributes for each load of the plurality of loads;
wherein the one or more processors are configured to:
evaluate the respective plurality of load attributes for each load, and
automatically group the plurality of loads into a plurality of load groups based on the respective plurality of load attributes for each load, and
cause the display unit to display the adaptive GUI based on the plurality of load groups, wherein the adaptive GUI is configured to selectively display the plurality of loads according to the plurality of load groups.

16. The microgrid HMI of claim 1, wherein the one or more memories are configured to store a plurality of attribute templates, including an attribute template for each energy resource system, wherein each attribute template defines the respective plurality of attributes for a respective energy resource system, and
wherein the one or more processors is configured to analyze the plurality of attribute templates and parse the plurality of energy resource systems into the plurality of groups based on attributes that are defined in the plurality of attribute templates.

17. The microgrid HMI of claim 16, wherein the one or more memories are configured to store a predefined template of an asset type and an editable template of the asset type,
wherein the predefined template includes a plurality of fixed attribute fields that include preconfigured attribute values for the asset type, wherein the preconfigured attribute values that are included in the plurality of fixed attribute fields are fixed,
wherein the editable template includes a plurality of editable attribute fields that include the preconfigured attribute values for the asset type, wherein the preconfigured attribute values that are included in the plurality of editable attribute fields are editable, and
wherein the one or more processors are configured to finalize attribute values in the plurality of editable attribute fields based on user input and store the editable template as one of the plurality of attribute templates.

18. The microgrid HMI of claim 17, wherein the one or more processors are configured to receive a selection of either the predefined template or the editable template to use for a respective energy resource system.

19. The microgrid HMI of claim 16, wherein the one or more processors are configured to duplicate a first microgrid configuration to generate a second microgrid configuration, and store the second microgrid configuration in the one or more memories.

20. A method of grouping assets associated with a microgrid, comprising:
storing, by a human-machine interface (HMI), asset information corresponding to a plurality of assets associated with the microgrid, wherein each asset of the plurality of assets is configured to supply power to the microgrid or sink power from the microgrid, and wherein the asset information defines a respective plurality of attributes for each asset of the plurality of assets;
evaluating, by the HMI, the respective plurality of attributes for each asset;
automatically grouping, by the HMI, the plurality of assets into a plurality of groups based on the respective plurality of attributes for each asset; and
generating an adaptive graphical user interface (GUI) based on the plurality of groups, wherein the adaptive GUI is configured to selectively display the plurality of assets according to the plurality of groups.
